(19) United States
(12) Patent Application Publication
(10) Pub. No.: US 2015/0234799 A1
(43) Pub. Date: Aug. 20, 2015

(54) METHOD OF PERFORMING TEXT RELATED OPERATION AND ELECTRONIC DEVICE SUPPORTING SAME

(71) Applicant: SAMSUNG ELECTRONICS CO., LTD., SUWON-SI (KR)

(72) Inventors: Guk Hwan CHO, Chilgok-gun (KR); Ki Chul SONG, Gumi-si (KR); Ji Woo LEE, Gumi-si (KR); In Soon KIM, Gumi-si (KR); Kyu Seok OH, Gumi-si (KR); Chul Ho YU, Gumi-si (KR)

(21) Appl. No.: 14/607,507

(22) Filed: Jan. 28, 2015

(30) Foreign Application Priority Data
Feb. 19, 2014 (KR) 10-2014-0018885

(51) Int. Cl. G06F 17/24; G06F 17/28; G06F 17/27; G06F 3/0484; G06F 3/0488

(52) U.S. Cl. CPC G06F 17/24; G06F 3/04842; G06F 3/04883; G06F 17/2735; G06F 17/2765; G06F 17/289

(57) ABSTRACT

An apparatus and method of operating a text related function are provided. The apparatus includes receiving a selection of at least one text region from displayed text, determining at least one classification for one of the at least one text region and the character information based on a connection relationship between at least one piece of character information included in the at least one text region selected, and processing a text related function associated with the at least one piece of character information according to the determined at least one classification.

### CROSS-REFERENCE TO RELATED APPLICATION(S)

This application claims the benefit under 35 U.S.C. §119(a) of a Korean patent application filed on Feb. 19, 2014 in the Korean Intellectual Property Office and assigned Serial number 10-2014-0018885, the entire disclosure of which is hereby incorporated by reference.

### TECHNICAL FIELD

The present disclosure relates to a method and apparatus of operating a text related function.

### BACKGROUND

With the development of an info-communication industry, electronic devices have become important means for transferring various pieces of information to users. Electronic devices may display various pieces of information via displays. For example, electronic devices may display text messages.

Also, electronic devices provide various types of applications, and users may use various languages in addition to their native languages through a web browser, a message, an E-book or an E-mail, and the like.

According to the existing art, text displayed on a display of an electronic device simply support a function of displaying specific information. Accordingly, a user who does not know a language of displayed text may have not understand the text. Also, since the meaning of the text has to be searched for, a user may need a further, repetitive operation. Accordingly, the electronic device fails to rapidly provide desired information to user and may be unnecessarily consumed a power due to repetitively the same operation.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method of operating a text related function.

Another aspect of the present disclosure is to provide a method of operating a text related function is provided. The apparatus includes an electronic device supporting the same that enable a text related function to be operated more intuitively and easily, for example.

In accordance with an aspect of the present disclosure, a method of operating a text related function is provided. The method includes receiving a selection of at least one text region from displayed text, determining at least one classification for one of the at least one text region or and the character information based on a connection relationship between at least one piece of character information included in the at least one text region selected, and processing a text related function associated with the at least one piece of character information according to the determined at least one classification.

In accordance with another aspect of the present disclosure, an electronic device is provided. The apparatus includes an input and output interface configured to sense at least one of a closed curve event including some of displayed text, a line-drawing event, a touch event, and a special symbol event, the input and output interface being configured to select at least one text region based on the at least one event and a processor configured to determine the at least one text region based on selection, analyze the connection relationship between the at least one piece of character information included in the at least one text region to determine at least one classification for the text region, and to process a text related function related to the at least one piece of character information included in the at least one text region according to determined classification.

According to another embodiment of the present disclosure, a storage medium storing commands is provided. The storage medium storing commands enable at least one processor to perform at least one operation when being executed by the at least one processor. The at least one operation includes selecting at least one text region from displayed texts, analyzing the connection relationship between the at least one piece of character information included in the selected text region to determine at least one classification for one of the at least one text region and the at least one piece of character information, and processing a text related function related to the at least one piece of character information included in the at least one text region according to the determined at least one classification.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a network environment including an electronic device according to an embodiment of the present disclosure.

FIG. 2 is a block diagram of a processor for controlling an electronic device according to an embodiment of the present disclosure.

FIG. 3 is a flow chart of a method of performing a text related function according to an embodiment of the present disclosure.

FIG. 4 is a diagram for explaining how to process a text related function according to an embodiment of the present disclosure.

FIG. 5 is a diagram illustrating an interface associated with text block selection according to an embodiment of the present disclosure.

FIG. 6 is a diagram illustrating a screen interface associated with function classification selection according to an embodiment of the present disclosure.

FIG. 7 is a diagram illustrating a screen interface associated with tag information generation according to an embodiment of the present disclosure.

FIG. 8 is a diagram illustrating a screen interface associated with a dictionary search function according to an embodiment of the present disclosure.

FIG. 9 is a diagram illustrating a screen interface linking a translation function to a dictionary function according to an embodiment of the present disclosure.

FIG. 10 is a diagram illustrating a screen interface associated with a capture function according to an embodiment of the present disclosure.

FIG. 11 is a block diagram of an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expression “include” or “may include” that may be used in the present disclosure indicates the presence of a disclosed corresponding function, operation or component but does not exclude one or more functions, operations or components in addition. Also, in the present disclosure, it should be understood that the term “includes” or “has” indicates the presence of characteristics, numbers, steps, operations, components, parts or combinations thereof represented in the present disclosure but does not exclude the presence or addition of one or more other characteristics, numbers, steps, operations, components, parts or combinations thereof.

The expression “or” in the present disclosure includes any and all combinations of enumerated words. For example, the expression “A or B” may include A, B, or both A and B.

The expression “a first”, “a second”, “firstly”, or “secondly” in the present disclosure may modify various components of the present disclosure but does not limit corresponding components. For example, the expressions above do not limit the order and/or importance of corresponding components. The expressions above may be used to distinguish one component from another component. For example, both a first user device and a second user device are user devices that are mutually different user devices. For example, without departing from the scope of rights of the present disclosure, a first component may be called a second component and similarly, the second component may also be called the first component.

When any component is referred to as being “connected” or “accessed” to another component, it should be understood that the former may be directly connected to the latter, or there may be another component in between. On the contrary, when any component is referred to as being “directly connected” or “directly accessed” to another component, it should be understood that there may be no other component in between.

The terms used in the present disclosure are used only to describe specific embodiments and are not intended to limit the present disclosure. The terms in singular form include the plural form unless otherwise specified.

Unless otherwise defined herein, all terms used herein including technical or scientific terms have the same meanings as those generally understood by a person skilled in the art. Generally used terms defined in dictionaries should be construed to have meanings matching with contextual meanings in the related art and are not construed as an ideal or excessively formal meaning unless otherwise defined herein.

An electronic device according to the present disclosure may be a device that includes text display and operation functions. For example, the electronic device may include at least one of a smart phone, a tablet Personal Computer (PC), a mobile phone, a video phone, an e-book reader, a desktop PC, a laptop PC, a net book computer, a Personal Digital Assistant (PDA), a Portable Multimedia Player (PMP), an MP3 player, a mobile medical device, a camera, and a wearable device (e.g., a Head-Mounted-Device (HMD) such as electronic glasses, electronic clothing, an electronic bracelet, an electronic necklace, an electronic appcessory, an electronic tattoo, and/or a smart watch).

According to various embodiments of the present disclosure, the electronic device may be a smart home appliance having text display and operation functions. The smart home appliance may include, for example, at least one of a TV, a Digital Video Disk (DVD) player, an audio set, a refrigerator, an air conditioner, a cleaner, an oven, a microwave oven, a washing machine, an air cleaner, a set-top box, a TV box (e.g., Samsung HomeSync™, Apple TV™, and/or Google TV™), a game console, an electronic dictionary, an electronic key, a camcorder, and an electronic frame.

According to various embodiments of the present disclosure, the electronic device may include at least one of various medical devices (e.g., a Magnetic Resonance Angiography (MRA) device, a Magnetic Resonance Imaging (MRI) device, a Computed Tomography (CT) device, a camera, and an ultrasonicator), a navigation device, a Global Positioning System (GPS) receiver, an Event Data Recorder (EDR), a Flight Data Recorder (FDR), a car infotainment device, electronic equipment for a ship (e.g., a navigation device for a ship and/or a gyro compass), avionics, a security device, and/or an industrial or home robot.

According to various embodiments of the present disclosure, the electronic device may include at least one of a portion of a building/structure or furniture including text display and operation functions, an electronic board, an electronic signature receiving device, a projector, or various measurement devices (e.g., water, electricity, gas and/or electric wave measurement devices). The electronic device according to the present disclosure may be one or more combinations of the above-described various devices. Also, it is obvious to a person skilled in the art that the electronic device according to the present disclosure is not limited to the above-described devices.

Electronic devices according to an embodiment of the present disclosure are described below with reference to the accompanying drawings. The term “user” used in an embodiment may refer to a person who uses an electronic device, or a device (e.g., an electronic device having artificial intelligence) that uses an electronic device.

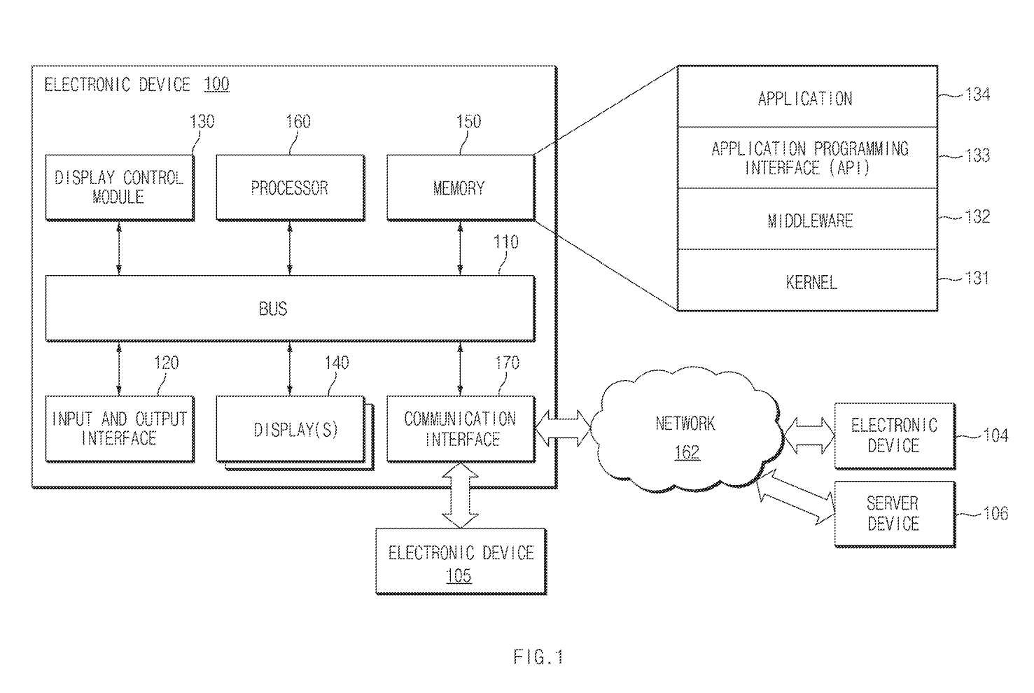

FIG. 1 shows a network environment including an electronic device according to an embodiment of the present disclosure.

Referring to FIG. 1, an electronic device 100 may include a bus 110, an input and output interface 120, a display control module 130, a display 140, a memory 150, a processor 160, and a communication interface 170, but is not limited thereto.

The bus 110 may be a circuit that connects the above-described device components to one another and transfers the communication (e.g., a control message) between the above-described device components. For example, the bus 110 may transfer data stored in the memory 150 to the display 140. The bus 110 may transfer data received through the communication interface 170 to the memory 150. The bus 110 may transfer an input signal input through the input and output interface 120 to the processor 160.

The processor 160 may receive commands from the above-described components (e.g., the memory 150, the input and output interface 120, the display 140, the communication interface 170, and/or the display control module 130) through the bus 110, decrypt received commands and perform calculation or data processing according to decrypted commands. According to an embodiment of the present disclosure, the processor 160 may display a text, process a function associated with a displayed text and display a result of performing a function.

The memory 150 may store commands or data that are received from the processor 160 and/or other components (e.g., the input and output interface 120, the display 140, the communication interface 170 and/or the display control module 130) or created by the processor 160 and/or other components. The memory 150 may include programming modules such as a kernel 131, a middleware 132, an application programming interface (API) 133 and/or an application 134. Each of the above-described programming modules may be configured in software, firmware, hardware or a combination of two or more thereof.

According to an embodiment of the present disclosure, the memory 150 may store at least one of a dictionary information database and a translation information database. In this case, the dictionary information database and/or the translation information database that is stored may include an information database provided by a country-based server device. According to an embodiment of the present disclosure, the memory 150 may receive and store a dictionary information database and/or a translation information database corresponding to country-based or region-based information included in subscriber identity module (SIM) information.

The kernel 131 may control or manage system resources (such as a bus 110, a processor 160 and/or a memory 150) used for performing an operation or function implemented in other remaining programming modules such as a middleware 132, an API 133 and/or an application 134. Also, the kernel 131 may provide an interface that enables the middleware 132, the API 133 and/or the application 134 to access and control or manage individual components of the electronic device 100.

The middleware 132 may function as an intermediary that enables the API 133 or the application 134 to communicate with the kernel 131 and thus transmit and receive data. Also, in order to process task related requests received from the application 134, the middleware 132 may perform a control on the task related requests (e.g., scheduling or load balancing) by assigning priority to use the system resource (e.g., the bus 110, the processor 160 and/or the memory 150) of the electronic device 100 to e.g., at least one of applications 134.

The API 133 is an interface for enabling the application 134 to control a function provided from the kernel 131 and/or the middleware 132 and may include at least one interface or function (e.g., a command) for a file control, a window control, image processing and a character control.

According to an embodiment of the present disclosure, the application 134 may include an SMS (short message service)/MMS (multimedia message service) application, an E-mail application, a calendar application, an alarm application, a health care application (e.g., an application measuring an exercise amount or blood sugar) or an environment information application (e.g., an application providing atmosphere, humidity, or temperature information). Additionally or alternatively, the application 134 may be an application related to an information exchange between the electronic device 100 and an external electronic device (e.g., an electronic device 104 or 105). The application related to the information exchange may include, for example, a notification relay application for relaying specific information to the external electronic device or a device management application for managing the external electronic device.

For example, the notification relay application may include a function of relaying notification information generated from other applications (e.g., an SMS/MMS application, an E-mail application, a health care application and an environment information application) to the external electronic device (e.g., the electronic device 104 or 105. Additionally or alternatively, the notification relay application may receive notification information from e.g., the external electronic device (e.g., the electronic device 104 or 105) and provide received information to a user. The device management application may manage (e.g., install and/or update) a function (e.g., the turn on/turn off operation of the external electronic device itself (or some parts thereof) and/or the brightness control of a display) of at least a portion of the external electronic device (e.g., the electronic device 104 or 105) communicating with the electronic device 100, an application operating on the external electronic device and a service (e.g., a call service or a message service) provided by the external electronic device.

According to an embodiment of the present disclosure, the application 134 may include a designated application according to the attribute (e.g., type) of the external electronic device (e.g., the electronic device 104 or 105). For example, when the external electronic device is an MP3 player, the application 134 may include an application related to music playback. Similarly, when the external electronic device is a mobile medical device, the application 134 may include an application related to health care. According to an embodiment of the present disclosure, the application 134 may include at least one of a designated application for the electronic device 100 and an application received from the external electronic device (e.g., the server device 106 or the electronic device 104).

According to an embodiment of the present disclosure, the application 134 may include an application that supports a text related function. A text application that supports the text related function may display at least a portion of a text stored in the memory 150, a text received through the communication interface 170 and a text input through the input and output interface 120, on the display 140. For example, according to an event input through the input and output interface 120 or an event occurring according to a defined schedule, the text related application may display at least one of translation information and dictionary information corresponding to at least a portion of text.

The input and output interface 120 may relay commands or data input from a user through an input and output device (e.g., a sensor, a keyboard and/or a touch screen), to the processor 160, the memory 150, the communication interface 170, and/or the display control module 130 through the bus 110. For example, the input and output interface 120 may provide the processor 160 with data on a user touch input through a touch screen. Also, the input and output interface 120 may output the commands or data received from the processor 160, the memory 150, the communication interface 170 and/or the display control module 130 through the bust 110, to the input and output device (e.g., a speaker or display), for example. For example, the input and output interface 120 may output voice data processed through the processor 160, to the speaker. According to an embodiment, the input and output interface 120 may output at least one of voice data corresponding to character information among text, dictionary information related data corresponding to character information among text and voice data corresponding to translation information.

The display 140 may display various pieces of information (e.g., multimedia data) to a user. According to an embodiment of the present disclosure, the display 140 may display text. The text may be at least one of dictionary information, translation information related to at least a portion of pieces of character information among texts and scrap information related to text.

The communication interface 170 may connect the electronic device 100 to the external device (e.g., the electronic device 104, 105 and/or the server device 106). For example, the communication interface 170 may be connected directly to the external electronic device (e.g., the electronic device 105) through wireless or wired communication or to the external electronic device (e.g., the electronic device 104 and/or the server device 106) via the network 162 to communicate with the external electronic device (e.g., the electronic device 104, 105, and/or the server device 106). The wireless communication may include at least one of a wireless fidelity (WiFi), Bluetooth (BT), near field communication (NFC), global positioning system (GPS) and cellular communication (e.g., LTE, LTE-A, CDMA, WCDMA, UMTS, WiBro or GSM) scheme. The wired communication may include at least one of a universal serial bus (USB), high definition multimedia interface (HDMI), recommended standard 232 (RS-232) and plain old telephone service (POTS) scheme.

The network 162 may be a telecommunication network. The telecommunication network may include at least one of a computer network, the internet, the internet of things and a telephone network. A protocol (e.g., a transport layer protocol, a data link layer protocol or a physical layer protocol) for communication between the electronic device 100 and the external device may be supported by at least one of the application 134, the application program interface 133, the middleware 132, the kernel 131 and the communication interface 170.

The server device 106 may be a device providing a dictionary information database or translation information database. Alternatively, the server device 106 may be a device that provides dictionary information or translation information. The communication interface 170 may access the server device 106 through the network 162, and receive at least one of dictionary information, a dictionary information database, translation information and a translation information database from the server device 106 according to the control of the processor 160. The communication interface 170 may transmit SIM information included in the electronic device 100 to the server device 106 according to the control of the processor 160. Alternatively, the communication interface 170 may extract country information or country and region information from SIM information according to the control of the processor 160 and transmit extracted information to the server device 106. The communication interface 170 may receive at least one of dictionary information related to country information and region information extracted from SIM, a dictionary information database, translation or a translation information database from the server device 106. The server device 106 may provide the electronic device 100 with a country-based dictionary information database or a country-based translation information database.

The display control module 130 may process at least a portion of information obtained from other components (e.g., the processor 160, the memory 150, the input and output interface 120, and/or the communication interface 170) and control other components (e.g., the display(s) 140) to provide a user with processed information in various methods. For example, the display control module 130 may generate information to be displayed on the display 140 by using the processor 160 or independently therefrom, and determine a location on which generated information is displayed. For example, when the display 140 includes a plurality of displays, the display control module 130 may display information on at least one of the displays.

At least a portion of the display control module 130 may be a graphic processor, for example. According to an embodiment, at least a portion of the display control module 130 may be included as a portion of a logic executed by the processor 160.

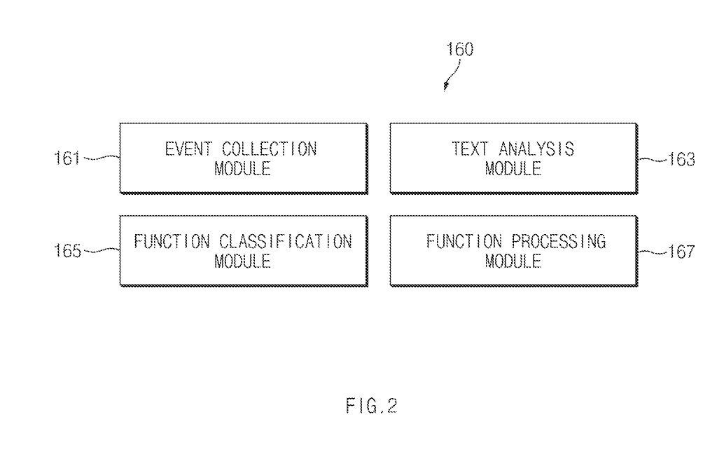

FIG. 2 is a block diagram of a processor for controlling an electronic device according to an embodiment of the present disclosure.

Referring to FIG. 2, the processor 160 may include an event collection module 161, a text analysis module 163, a function classification module 165 and a function processing module 167.

The event collection module 161 may collect an event corresponding to a text related function, for example. In this context, the event collection module 161 may enable at least one icon and file image corresponding to a text related function to be displayed on the display 140. For example, the text related function may include the functions of writing a message, showing a stored message, writing a note, showing a stored note, writing or showing a document, and/or an E-book related function. Also, the text related function may include a function of displaying a web document including text, a function of arranging and/or showing a schedule. When a touch event (e.g., a long press, a touch, a swipe, a tap, a flick or a drag) for selecting a corresponding icon or file image occurs, the event collection module 161 may enable a text file selected by the touch event to be displayed on the display 140.

The event collection module 161 may collect an event that occurs on a region on which a text is displayed among at least a portion of the display 140. For example, the event collection module 161 may collect a designating event designating character information included in a text, such as at least a morpheme unit, a specific word unit, a word unit, a phrase unit, a paragraph unit or a sentence unit. The designating event may include an event selecting at least a portion of a text by using a finger or a touch tool (e.g., an electronic pen). Such a designating event may include a drag event, a tap event or a flick event. The designating event may include a drag event corresponding to a closed curve including at least a portion of a text or a line-drawing event (e.g., drawing a line by using an electronic pen). When at least a portion of a text is selected, the event collection module 161 may relay character information corresponding to a selected text region to a text analysis module 163, a function classification module 165 or a function processing module 167.

The text analysis module 163 may perform analysis on character information received from the event collection module 161, for example. It is possible to perform an error check on character information. For example, when performing the error check, the text analysis module 163 may identify character information based on word spacing. The text analysis module 163 may check whether words separated by the word spacing are meaningful words or are formed by integrating words having a plurality of meanings. The text analysis module 163 may perform an error check on identifying a word through the adjustment of the word spacing.

The text analysis module 163 may perform at least one of agglutinative language processing, inflectional language processing or isolating language processing on words identified based on the word spacing. For example, the text analysis module 163 may perform an operation of removing postposition or ending from an agglutinative language such as Hangul, in which postposition or ending is attached to a word. Accordingly, the text analysis module 163 may extract words to be applied to search for dictionary information. The text analysis module 163 may relay analyzed agglutinative language information, analyzed inflectional language information or analyzed isolating language information along with analyzed word information to the function processing module 167.

The function classification module 165 may perform a classification function on selected character information, for example. For example, the function classification module 165 may check whether words on a selected text region are separated words or connected words or include both separated words and connected words. In addition, the function classification module 165 may classify text regions according to the characteristic of words arranged on selected text regions. When the classifying of the text regions is completed, the function classification module 165 may enable a menu including a dictionary function selection item, a translation function selection item or a capture function (e.g., a scrapbook) selection item to be displayed. The function classification module 165 may relay selection information selected by a user input to the text analysis module 163 when a user input selecting an item included in a menu occurs.

The function classification module 165 may select or recommend a specific function according to the characteristic of character information selected. For example, when a block selecting at least a portion of text includes a word, the function classification module 165 may automatically select or recommend any one of a dictionary function or a translation function. The function classification module 165 may select a capture function when a block selecting at least a portion of text is a certain closed curve region that includes character information such as a plurality of words or phrases. The function classification module 165 may relay the selection information to the function processing module 167.

The function processing module 167 may perform, for example, at least one of a dictionary function, a translation function and a capture function based on character information relayed by selection information relayed from the function classification module 165 or character information relayed from the text analysis module 163. For example, the function processing module 167 may perform a dictionary search function on character information relayed from the text analysis module 163 when information on a dictionary function item is received from the function classification module 165. In this operation, the function processing module 167 may search for dictionary information on a dictionary information data base stored in the memory 150. The function processing module 167 may enable found dictionary information to be displayed on the display 140. The function processing module 167 may detect the original form of a word according to the language characteristic of a word in the operation of performing the dictionary search function, and display dictionary information based thereon. For example, in the case of an agglutinative language, the function processing module 167 may receive the original form of a word without postposition or ending from the text analysis module 163 and perform a dictionary information search on a received word. In the case of an inflectional language, the function processing module 167 may receive information on the original form of a word of an inflectional language from the text analysis module 163 and perform a dictionary information search on the original form of the word received.

When a dictionary information database does not exist in the memory 150, the function processing module 167 may perform an operation of downloading a corresponding dictionary information database. For example, the function processing module 167 may check SIM information on the electronic device 100 and collect information on a country or region in which the electronic device 100 is used. Based on collected information, it is possible to perform an access to a server device 106 that provides a specific country or region's language based dictionary information database. When receiving the dictionary information database from the server device 106, the function processing module 167 may store the database on the memory 150 and use the database for supporting a dictionary function.

The function processing module 167 may transmit a word provided by the text analysis module 163 to the server device 106. In this operation, the function processing module 167 may check SIM information or information on a carrier currently providing a service to check country or region information. The function processing module 167 may automatically access a server device 106 that provides dictionary information (e.g., the original form of a specific word or the definition of a text) on a language corresponding to country or region information, and may transmit, to the server device 106, a word requested to apply a dictionary function or a selected text. The function processing module 167 may receive dictionary information from the server device 106. The function processing module 167 may enable received dictionary information to be displayed on the display 140.

The function processing module 167 may receive the original forms of a plurality of words from the text analysis module 163. The function processing module 167 may collect dictionary information on the original forms of a plurality of words. The function processing module 167 may enable dictionary information to be displayed on the display 140. The function processing module 167 may scroll and display dictionary information on the original forms of a plurality of words according to a scroll input event.

The function processing module 167 may receive selection information on a translation function item from the function classification module 165. The function processing module 167 may perform a translation function on the original form of a word received from the text analysis module 163. For example, the function processing module 167 may transmit, to a server device 106 supporting a translation function, a word's original form (e.g., a word obtained through agglutinative language processing or inflectional language processing for a dictionary search) a text selected by a user and receive translation information from the server device 106. The function processing module 167 may receive a translation information database from the server device 106. The function processing module 167 may store a received translation information database on the memory 150 and detect translation information on the original form of a word by using the translation information database stored in the memory 150.

The function processing module 167 may receive the postposition, ending or word of an agglutinative language together from the text analysis module 163. The function processing module 167 may detect translation information including the ending or postposition of an agglutinative language. The function processing module 167 may receive information on the tense of an agglutinative language or information on a person from the text analysis module 163. The function processing module 167 may detect translation information to which the information on the tense of the agglutinative language or the information on the person is applied. The function processing module 167 may perform translation based on a sentence.

The function processing module 167 may provide translation information on the entire character information arranged on some regions selected from text (e.g., text included in a message, a memo, an e-mail, a note, an E-book) when receiving capture function selection information from the function classification module 165. For example, the function processing module 167 may display image information on scrapped character information. The function processing module 167 may identify scrapped character information based on a sentence and display image information based on a sentence. The function processing module 167 may provide translation information on sentences that are arranged based on each piece of image information.

The function processing module 167 may further search for a word similar or opposite to an extracted word. In this operation, the function processing module 167 may search for dictionary information on the word similar or opposite to the extracted word based on a database stored in the memory 150. The function processing module 167 may display the original form of a word, a similar word or an opposite word on the display 140. The function processing module 167 may collect translation information on the original form of a word, a similar word or an opposite word. The function processing module 167 may enable received translation information to be displayed on the display 140.

An electronic device 100 may include an input and output interface that senses at least one of an event related to a closed curve including at least some of displayed text, a line-drawing event, a touch event and an event related to a special symbol, and selects at least one test region based on the at least one event, and the processor 160 that determines the at least one test region based on the selection, analyzes the connection relationship between at least one or more pieces of character information included in the text region to determine at least one classification for the text region and processes a text related function related to at least one piece of character information included in the text region.

The processor 160 may select the at least one text region based on at least one of the event related to a closed curve including some of text, the line-drawing event, the touch event and the event related to the special symbol.

The processor 160 may determine selected text as at least one text region when another text is further selected within a designated time period after some of text are selected.

The processor 160 may classify as a separated word when the text region includes one word, as a connected word when the text region includes a plurality of words, and as a mixed word when the separated word and the connected word are mixed.

The processor 160 may control the display of dictionary information over the separated word when the text region including the separated word is selected, control the display of dictionary information over the connected word when the text region including the connected word is selected, and capture, display and store the text region as at least one image when the text region including the mixed word is selected.

The processor 160 may control the display of at least one of at least one of dictionary information and translation information corresponding to a captured text region, dictionary information on at least one of the connected words and translation information on the separated word.

The 160 processor may perform at least one of an error check on at least one piece of character information included in the text region, and agglutinative language processing and inflectional language processing for extracting the original form of a word on at least one piece of character information included in the text region.

The processor may display at least one of at least one piece of character information included in the text region, the original form of the word according to the agglutinative language processing or inflectional language processing, dictionary information on the original form of the word, and words similar and opposite to at least one of the character information and the original form of the word.

The processor 160 may receive at least one of a dictionary information database or a translation information database supporting the text related function from the server device 106, according to SIM information on an electronic device or country-based or region-based information on a carrier currently providing a service.

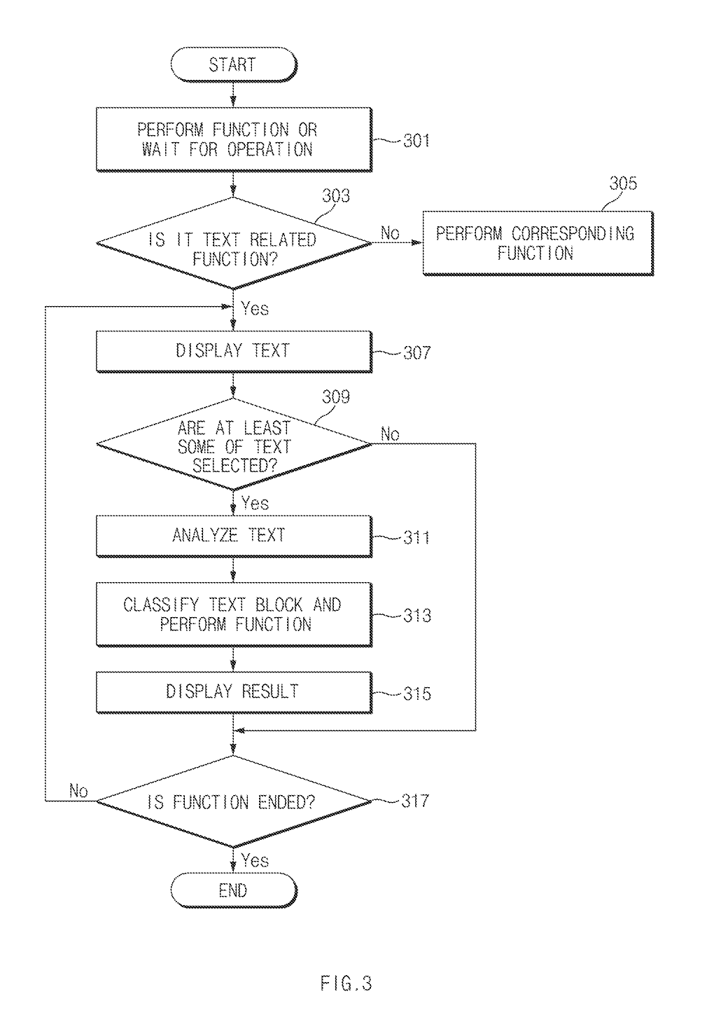

FIG. 3 is a flow chart of a method of performing a text related function according to an embodiment of the present disclosure.

Referring to FIG. 3, in the method of performing the text related function, the processor 160 may control the function operation or standby of the electronic device 100 in operation 301. The processor 160 may display an object or item including an icon, a notification or a menu for executing a text based application, on the display 140.

In operation 303, the processor 160 may check whether an event related to the activation of the text related function occurs. For example, the processor 160 may receive an event related to selecting the object. Also, the processor 160 may check whether an event requesting to display stored text (e.g., a message, a memo, an e-mail, a note, and an E-book) or an event requesting to display a web page including text occurs.

In operation 303, when there is no event related to the activation of the text related function, the processor 160 may proceed to operation 305 to enable a corresponding function to be performed. For example, the processor 160 may perform a music playback function or a gallery function according to the type of an event that has occurred.

In operation 303, when an event for the activation of the text related function occurs, the processor 160 may display a text corresponding to the event on the display 140 in operation 307. For example, according to the event that has occurred, the processor 160 may display a text according to E-book function execution, a text according to a document display, a text according to a web page display or a text according to a text message and/or email display.

In operation 309, the processor 160 may check whether an event in which at least some of text is selected occurs. For example, the processor 160 may check an event according to text block selection corresponding to at least some of text. The event related to the text block selection may include an event corresponding to the operation of drawing a line across a text by using at least one of a finger or an electronic pen, an event corresponding to the operation of drawing a special symbol such as a rectangular box, a lattice or a parenthesis on specific character information, or an event corresponding to the operation of drawing a closed curve on a specific text region. Character information included in a text block may include at least one word. Words may be identified by the word spacing. For example, character information may include information on an agglutinative language including a noun and postposition or an inflectional language such as a tense form related to a word's original form, a personal form or a singular or plural form. The text block may include a plurality of words. Also, the text block may also include a plurality of sentences. The operation of selecting the text block may include an operation of continuously selecting a plurality of text blocks. The processor 160 may check continuity in selecting a plurality of text blocks to check whether the selection of text blocks is completed. For example, the processor 160 may process that an event related to the selection of continuous text blocks has occurred, when a text block event occurs within a certain time period after a specific text block is selected. In this case, the processor 160 may defer an analysis operation on the specific text block and perform the analysis operation on the specific text block and the continuous text block after the selection of the continuous text block is completed.

When at least some of text is selected in operation 309, the processor 160 may perform text analysis on selected regions in operation 311. For example, the text analysis may include one of an error check, inflectional language processing, agglutinative language processing, or isolating language processing. The processor 160 may perform an analysis operation on a selected text block when a certain time elapses. Alternatively, the processor 160 may perform an analysis operation when an event selecting a specific text block occurs by default. Alternatively, when an event or menu selection corresponding to block selection completion after a specific text block is selected occurs, the processor 160 may perform an analysis operation on a selected text block. When there is no text selection in operation 309, the processor 160 may skip operations 311, 313 and 315 and proceed to operations before operation 317.

In operation 313, the processor 160 may classify text blocks and process functions. When at least one of a text block including a plurality of words or a text block including a word and a text block including a plurality of words is selected, the processor 160 may identify the type of each text block. For example, when a function for a text block including a word is processed, the processor 160 may provide the definition of a corresponding word based on a dictionary information database. The processor 160 may provide translation information by using a translation information database when a function for a text block including a plurality of words is processed. According to an embodiment, the processor 160 may provide dictionary information or translation information when a text block including a word and a text block including a plurality of words are selected. In this operation, the processor 160 may provide a capture function (e.g., scrapbook function) in which selected text blocks are stored as at least one image format.

The processor 160 may provide translation information for a text block including a word in response to a user setting or a user request. Also, the processor 160 may also provide dictionary information for a text block including a plurality of words. In this operation, the processor 160 generates minimum search word data or tag information through the check of the original form of a word included in a text block. The processor 160 may perform an error check, agglutinative language processing, inflectional language processing or isolating language processing in order to discover the original form of word. The error check, agglutinative language processing or inflectional language processing may be performed based on a pre-stored database. Table 1 illustrates the error check, the inflectional language check and the agglutinative language check of the processor 160.

TABLE 1

| | Before | After | Before | After |
|---|---|---|---|---|
| Example of | [symbol] | [symbol] | [symbol] | [symbol] |
| Error Check | | | | |
| Example of | Functions | Function | Connected | connect |
| Inflectional | | | | |
| Language | | | | |
| Processing | | | | |
| Example of | [symbol] | [symbol] | [symbol] | [symbol] |
| Agglutinative | | | | |
| Language | | | | |
| Processing | | | | |

In operation 315, the processor 160 may control a result display. For example, the processor 160 may display dictionary information on a text block when a dictionary function is executed. The processor 160 may display translation information on a text block when a translation function is executed. Alternatively, the processor 160 may display at least one of dictionary information or translation information on a text block according to whether a dictionary function or a translation function is executed.

In operation 317, the processor 160 may check whether an event related to a function end occurs. When a function end related event occurs in operation 317, the processor 160 may return to operation 301 to re-perform operations. When a function end related event does not occur in operation 317, the processor 160 may return to before operation 307 to re-perform operations.

A method of operating a text related function may include the operation of selecting at least one text region of displayed text, the operation of analyzing the connection relationship between at least one piece of character information included in the selected text region to determine at least one classification on the text region or the character information, and the operation of processing a text related function related to at least one piece of character information included in the text region according to determined classification.

The operation of selecting may include the operation of selecting the at least one text region based on at least one of a closed curve event including at least some of displayed text, a line-drawing event, a touch event or a special symbol event.

The operation of selecting may include the operation of determining selected text as at least one text region when another text is further selected within a designated time period after some of text is selected.

The operation of determining the classification may include at least one of the operations of classifying as a separated word when the text region includes one word, as a connected word when the text region includes a plurality of words, and as a mixed word when the separated word and the connected word are mixed.

The method may include the operation of displaying a menu including at least one of a dictionary function, a translation function or a capture function, and the operation of processing the function related to at least one piece of character information included in the text region according to the function selected from the menu.

The operation of processing may include at least one of the operation of collecting and displaying dictionary information on the separated word when the text region including the separated word is selected, the operation of displaying dictionary information on the connected word when the text region including the connected word is selected, and the operation of capturing, displaying and storing the text region as at least one image when the text region including the mixed word is selected.

The operation of processing may include at least one of the operations of displaying: translation information on the separated word dictionary information on at least one of the connected words and at least one of translation information and dictionary information corresponding to the captured text region.

The operation of processing may include at least one of the operation of performing an error check on at least one piece of character information included in the text region, the operation of performing agglutinative language processing on at least one piece of character information included in the text region to extract the original form of a word, and the operation of performing inflectional language processing on at least one piece of character information included in the text region to extract the original form of a word.

The operation of processing may include at least one of the operation of displaying dictionary information on the original form of the word, the operation of displaying at least one of the original forms of the words according to the agglutinative language processing or the inflectional language processing as tag information and the operation of displaying at least one of words similar or opposite to at least one of the character information and the original form of the word as tag information.

The method may further include the operation of checking SIM information of an electronic device or information on a carrier currently providing a service, the operation of checking country-based or region-based information on the SIM information or the information on the carrier currently providing the service, and the operation of receiving at least one of a translation information database or a dictionary information database supporting the text related function from a server device according to a country or a region.

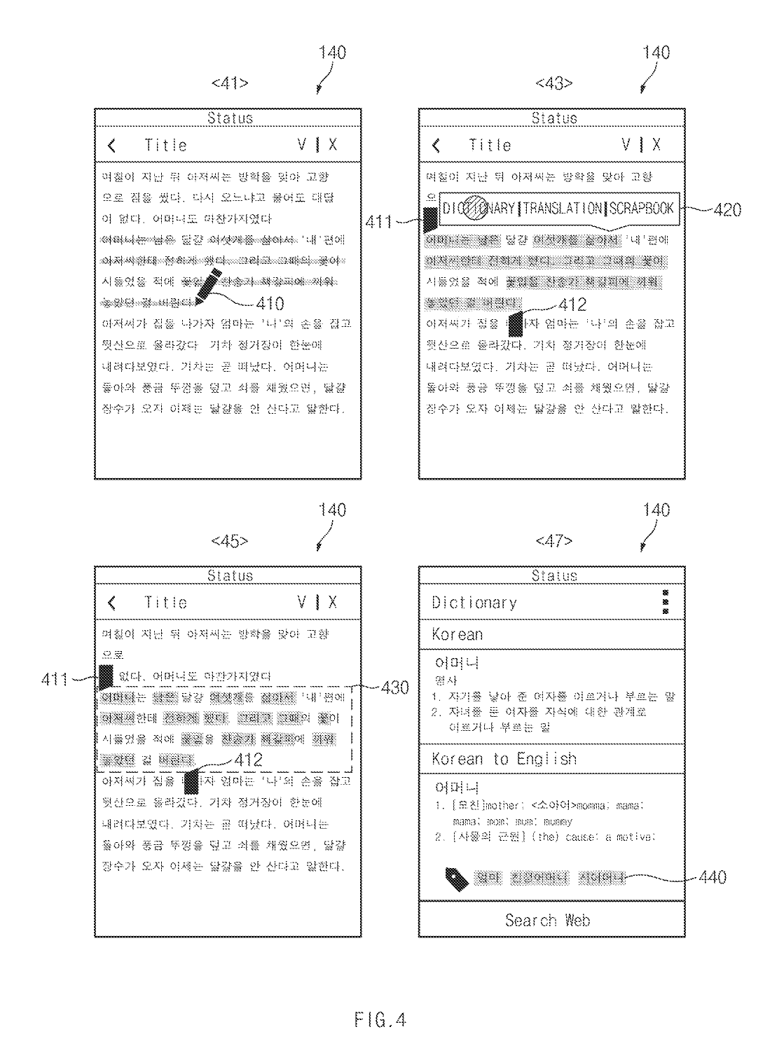

FIG. 4 is a diagram for explaining how to process a text related function according to an embodiment of the present disclosure.

Referring to FIG. 4, the display 140 may display a text screen as shown in screen 41 in response to a text display request. A user may use his or her finger or an electronic pen 410 to select a text block corresponding to at least some regions of text. For example, a touch event corresponding to line drawing may occur on a certain region by using the electronic pen 410. The processor 160 may determine a corresponding touch event as a text block selection event when a touch event selecting a certain region occurs.

When text block selection is completed, the processor 160 may display a menu classification menu 420 as shown in screen 43. For example, when a certain time after the text block selection elapses, the processor 160 may display the function classification menu 420 on a region on which a corresponding text block is arranged or an adjacent region. The processor 160 may perform text analysis according to an item selected from the function classification menu 420. For example, when a dictionary item is selected from the function classification menu 420, the processor 160 may perform analysis on text blocks. For example, the processor 160 may perform analysis by removing postposition and ending from an agglutinative language and extracting the original form of a word. When at least some regions of text are selected, the processor 160 may enable range information on a selected region to be displayed by using special symbols 411 and 412. Also, the processor 160 may provide a display effect (e.g., a highlight effect) for selected text blocks.

The display 140 may display a text block 430 including the original forms of words which are obtained by removing ending or postposition from agglutinative languages, as shown in screen 45. For example, a text block “ [symbol] ” selected on screen 43 may be changed to a text block “ [symbol] ” taken by selecting the original form of a word on screen 45.

The processor 160 may collect dictionary information on words when the detection of the original forms of words is completed. The processor 160 may use a dictionary information database stored in the memory 150 or transmit the original form of a word to the server device 106 and receive corresponding dictionary information. The display 140 may display dictionary information on a word selected by a specific text block as shown on screen 47. When a scroll event occurs on screen 47, the display 140 may display dictionary information on a word selected by another text block. According to an embodiment of the present disclosure, the display 140 may display an associated word 440 that is associated with a specific word included in a text block. The processor 160 may detect the associated word 440 based on a dictionary information database stored in the memory 150. In this context, the dictionary information database may store information on associated words for a specific word.

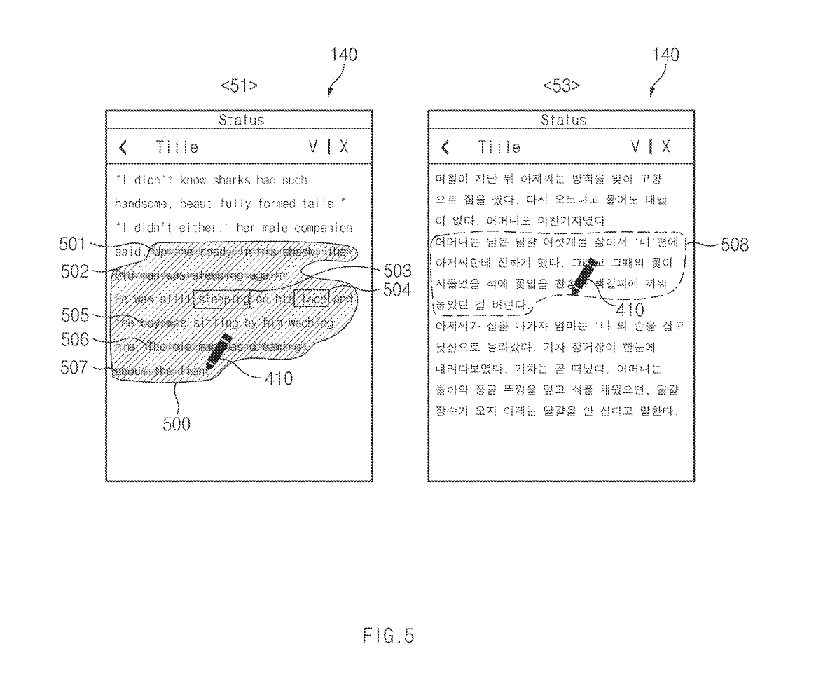

FIG. 5 is a diagram illustrating an interface associated with text block selection according to an embodiment of the present disclosure.

Referring to FIG. 5, the display 140 may display a screen including certain text as shown in screen 51. A user may use a touch tool such as an electronic pen 410 to designate a text block that includes at least some of text. For example, the processor 160 may collect a touch event underlining some regions of text by using the electronic pen 410 or receive a touch event drawing a rectangular box, a lattice or a parenthesis as a touch event related to a text block. According to an embodiment, the processor 160 may identify a word and a sentence in a text block based on the word spacing.

On screen 51, text blocks 500 to 507 include at least one word. For example, a word is identified by the word spacing and represents an agglutinative language including a noun and postposition. Alternatively, a word may represent an inflectional language including the tense form of infinitive or a personal form or a singular or plural form like English. According to an embodiment, the processor 160 may check whether the selection of a text block is completed, based on whether a certain time elapses between intervals at which text blocks 500 to 507 are generated. For example, the processor 160 may determine whether the selection of a text block is completed, according to whether a certain time elapses between the operations of selecting a first text block 501 and a second text block 502. According to an embodiment, the processor 160 may leave out checking the connection relationship between words when a text block including a word is selected. For example, when at least one of a text block including a plurality of words, a text block including a word, or a text block including a plurality of words is multiply selected, the processor 160 may identify the type of each text block.

The processor 160 may identify text blocks 503 and 504 as text blocks in which a word is a separated word, on screen 51. The processor 160 may recognize text blocks 501, 502, 506 and 507 as text blocks in which a plurality of words are connected words. The processor 160 may recognize the text block 500 as a multiple text block including text blocks having temporal continuity, when the text block 500 is formed by using text blocks including a word and text blocks including a plurality of words. For example, the processor 160 may recognize a text block 508 on screen 53, as a multiple text block having temporal continuity and including text blocks including a word and text blocks including a plurality of words, as in the text block 500.

The processor 160 may provide a related function according to the classification of the text blocks 500 to 507. For example, the processor 160 may support a dictionary information providing function for the text blocks 503 and 504, each of which includes a word. The processor 160 may provide translation information for the text blocks 501, 502, 506 and 507, each of which includes a plurality of words. The processor 160 may provide all of dictionary information, translation information and a capture function for the text block 500. Also, the processor 160 may provide all of dictionary information, translation information and a capture function for the text block 508.

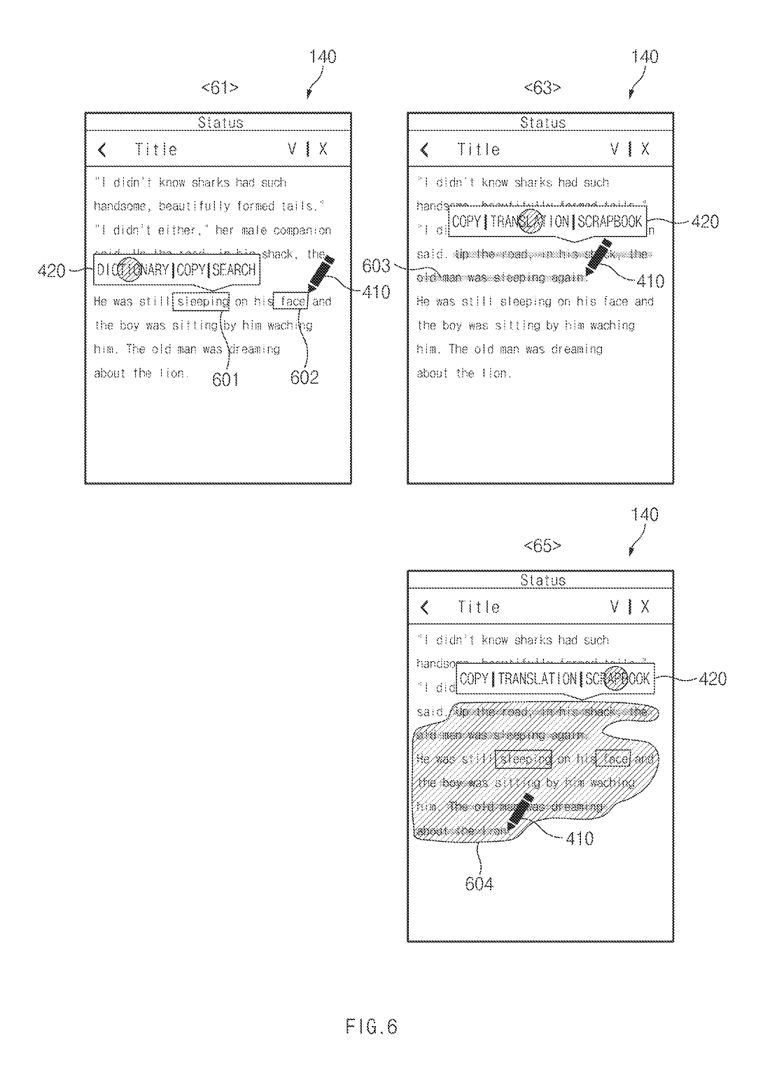

FIG. 6 is a diagram illustrating a screen interface associated with function classification selection according to an embodiment of the present disclosure.

Referring to FIG. 6, the display 140 of the electronic device 100 may display a screen including text. The processor 160 may check text block section according to a touch event that occurs by using the electronic pen 410 on the display 140. For example, when a touch event drawing a rectangular box, a lattice or a parenthesis on a certain region of text occurs as shown on screen 61, the processor 160 may see regions on which corresponding rectangular boxes are drawn. The processor 160 may display the function classification menu 420 for character information included in the rectangular boxes. In this operation, the processor 160 may apply a dictionary function by default to character information included in text blocks 601 and 602 that correspond to the rectangular boxes. Alternatively, the processor 160 may indicate a dictionary function item as a propose function related to the text blocks 601 and 602 on the function classification menu 420. According to an embodiment, the processor 160 may control dictionary information search and display for character information included in the text block 601 or 602, when an input event corresponding to confirmation occurs. In this operation, the processor 160 may analyze the text block 601 or 602 and perform or propose a dictionary function by default when the text block is a text block including a word as an analysis result.

A user may use an electronic pen 410 to select some regions of text and create a text block 603 as shown on screen 63. For example, when a line-drawing touch event occurs by using the electronic pen 410 on some regions of text, the processor 160 may determine a region indicated by the line-drawing touch event, as the text block 603. The processor 160 may perform analysis on the text block 603 when the text block 603 is selected. The processor 160 may propose a translation function item, providing the menu classification menu 420. Alternatively, the processor 160 may also perform a translation function without displaying the function classification menu 420. Alternatively, the processor 160 may perform a translation function on the text block 603 when a translation function item is selected from the function classification menu 420.

The processor 160 may recognize a text block 604 including certain regions of text according to a touch event that has occurred. For example, when a drawing event (e.g., an event drawing a free curved line) drawing a certain range corresponding to the text block 604 occurs, the processor 160 may recognize a corresponding event as the text block 604. When a drawing event including a certain range such as a text block 604 occurs, the processor 160 may recommend a capture function, displaying the function classification menu 420 as shown on screen 65. Alternatively, the processor 160 may also perform a capture function without displaying the function classification menu 420.

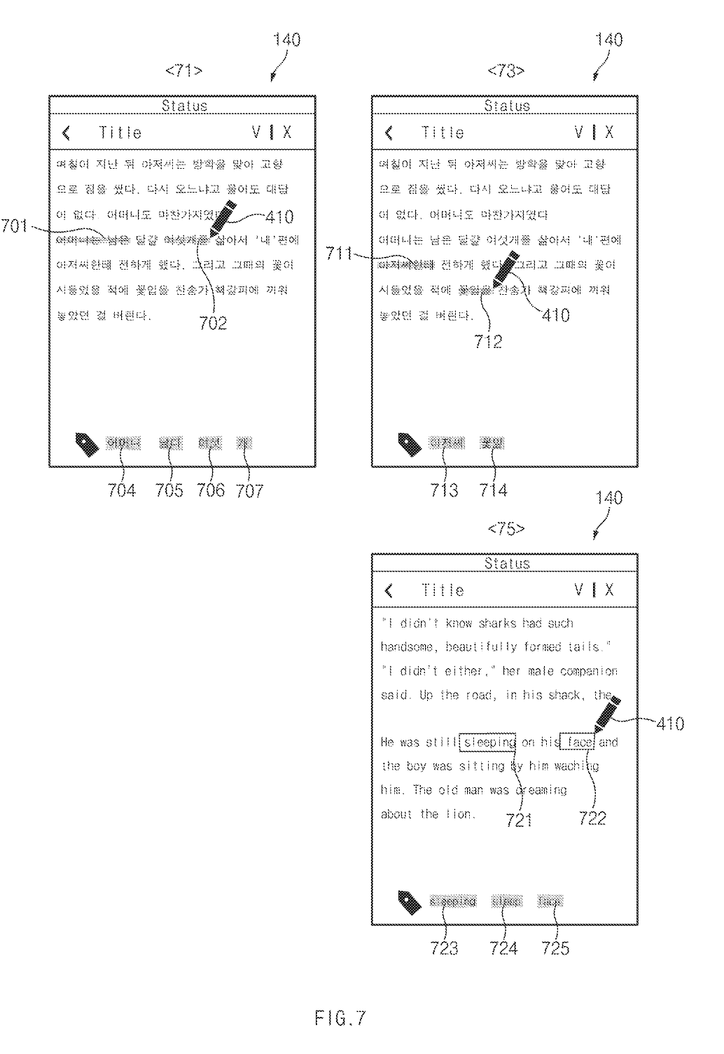

FIG. 7 is a diagram illustrating a screen interface associated with tag information generation according to an embodiment of the present disclosure.

Referring to FIG. 7, the display 140 may display screen 71 including certain text. A user may use a touch tool such as an electronic pen 410 to select certain patterns of text. The processor 160 may recognize text blocks 701 and 702 according to a touch event that has occurred. The processor 160 may provide a display effect for the text blocks 701 and 702.

The processor 160 may perform an error check or agglutinative language processing on selected text blocks 701 and 702. For example, the processor 160 may check an error in word spacing on the text block 701 “ [symbol] ” and analyze the text block as “ [symbol] ”. Also, the processor 160 may check an error in word spacing on the text block 702 “ [symbol] ” and analyze the text block as “ [symbol] ”. Also, the processor 160 may analyze and process “ [symbol] ” as “ [symbol] ”, “ [symbol] ”, as “ [symbol] ”, and “ [symbol] ” as “ [symbol] ”, according to agglutinative language processing. The processor 160 may perform tag information generation based on an analysis result. For example, the processor 160 may generate “ [symbol] ” 704, “ [symbol] ” 705, “ [symbol] ” 706, and “ [symbol] ” 707 as tag information.

The display 140 may display screen 73 in response to a specific text display request. When a touch event occurs by the electronic pen 410, the processor 160 may recognize text blocks 711 and 712 according to a corresponding touch event. The processor 160 may provide a display effect for the text blocks 711 and 712. The processor 160 may perform analysis on the text blocks 711 and 712. In this operation, the processor 160 may perform an error check or agglutinative language processing. For example, the processor 160 may change “ [symbol] ” to “ [symbol] ” for error correction. The processor 160 may change “ [symbol] ” to “ [symbol] ” for error correction. Also, the processor 160 may detect the original form of a word through agglutinative language processing. For example, the processor 160 may extract “ [symbol] [symbol] ” from an error-corrected word “ [symbol] ”. The processor 160 may extract “ [symbol] ” from an error-corrected word “ [symbol] ”. The processor 160 may generate “ [symbol] ” 713 and “ [symbol] ” 714 as tag information for extracted words. Accordingly, the display 140 may display “ [symbol] ” 713 and “ [symbol] ” 714 as tag information on one side of a screen.

The display 140 may display screen 75 in response to a specific text display request. When a touch event for a specific symbol or a specific drawing shape occurs by the electronic pen 410, the processor 160 may recognize text blocks 721 and 722 according to a corresponding touch event. The processor 160 may perform analysis on the text blocks 721 and 722. In this process, the processor 160 may detect the original form of a word through agglutinative language processing. For example, the processor 160 may perform agglutinative language processing on the word “sleeping” and extract the original form “sleep”. The processor 160 may extract the original form of the word “face”. The processor 160 may generate “sleeping” 723, “sleep” 724 and “face” 725 as tag information for extracted words. Accordingly, the display 140 may display “sleeping” 723, “sleep” 724 and “face” 725 as tag information on one side of a screen.

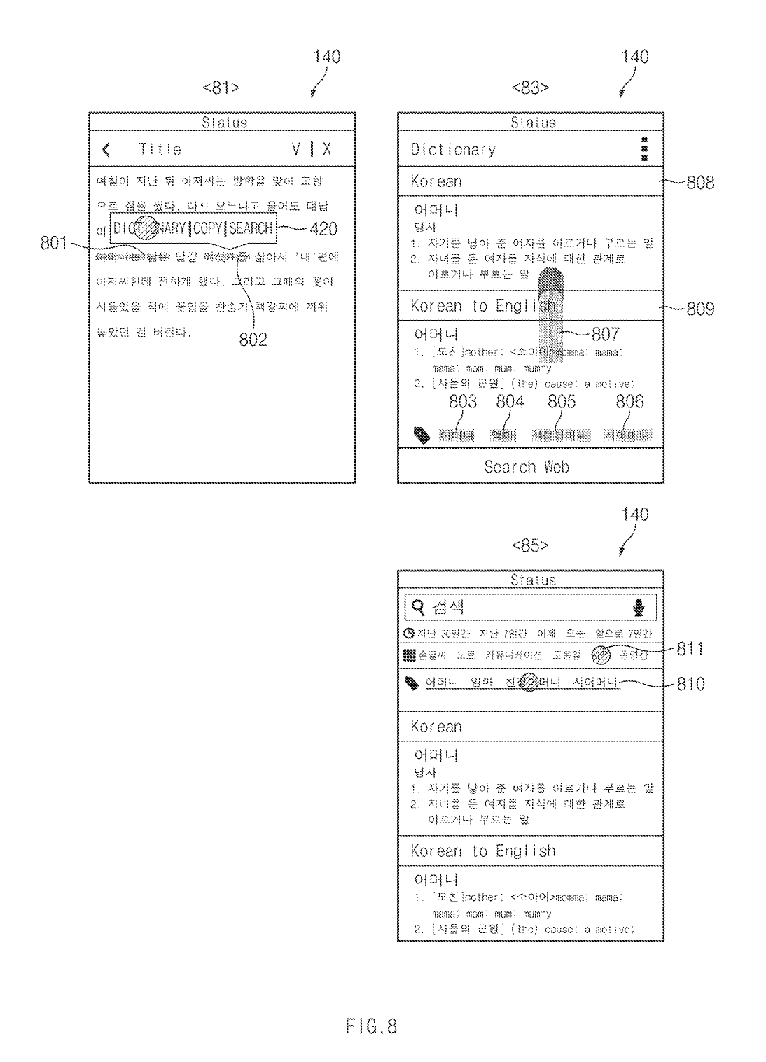

FIG. 8 is a diagram illustrating a screen interface associated with a dictionary search function according to an embodiment of the present disclosure.

Referring to FIG. 8, the display 140 may display screen 81 in response to a text display request. The processor 160 may recognize text blocks 801 and 802 by an event that has occurred. The processor 160 may display the function classification menu 420 when recognizing text blocks 801 and 802. The processor 160 may collect dictionary information corresponding to the text blocks 801 and 802 when a dictionary item is selected from the function classification menu 420. The display 140 may display dictionary information corresponding to the text blocks 801 and 802 as shown on screen 83.

The processor 160 may extract a query or tag information that is minimum search word data through the check of the original form of a word in response to dictionary item selection, referring to screen 71 of FIG. 71. For example, it is possible to extract “ [symbol] ” 704, “ [symbol] ” 705, “ [symbol] ” 706 and “ [symbol] ” 707. The processor 160 may search for extracted tag information 440 based on a dictionary information database stored in the memory 150. In this operation, the processor 160 may not perform display when there is no result related to tag information. The processor 160 may check SIM information or information on a carrier currently providing a service to operate a dictionary information database. Accordingly, it is possible to receive a dictionary information database from the server device 106 according to a country or region and store the database in the memory 150. According to an embodiment, a plurality of dictionary information databases may be stored in the memory 150. In this case, the processor 160 may perform a search on the plurality of dictionary information databases in a pre-selected order. The display 140 may display a search result 808 detected based on a Korean dictionary information database on screen 83.

The processor 160 may provide a translation function by default. In this case, the display 140 may display a translation result 809. When a scroll event 807 occurs, the processor 160 may display a search result of tag information such as “ [symbol] [symbol] ”, “ [symbol] ” and “ [symbol] ” on the display 140. The processor 160 may display associated words such as words similar or opposite to words included in the text blocks 801 and 802. For example, it is possible to display words associated with “ [symbol] [symbol] ” 803 that is tag information on the text block 801, such as “ [symbol] ” 804, “ [symbol] [symbol] ” 805, and “ [symbol] ” 806.

When receiving a result related to associated words for tag information from a dictionary information database, the processor 160 may display tag information 810 on associated words (such as a query, similar word or opposite word) as shown on screen 85. The tag information 810 may be linked to a dictionary search through the internal search function of an electronic device. For example, it is possible to execute a specific app (e.g., Galaxy's S Finder Function) like a vocabulary list function, display tag information on a dictionary 811 category through a corresponding app and access a corresponding dictionary 811 search result.

The processor 160 may provide a translation information database result as a result related to associated words for tag information. For example, the processor 160 may collect translation information on “ [symbol] ” 803, “ [symbol] ” 804, “ [symbol] [symbol] ” 805, and “ [symbol] ” 806 and display collected translation information as associated words. Also, the processor 160 may provide information on words similar or opposite to at least one of pieces of translation information, as associated words.

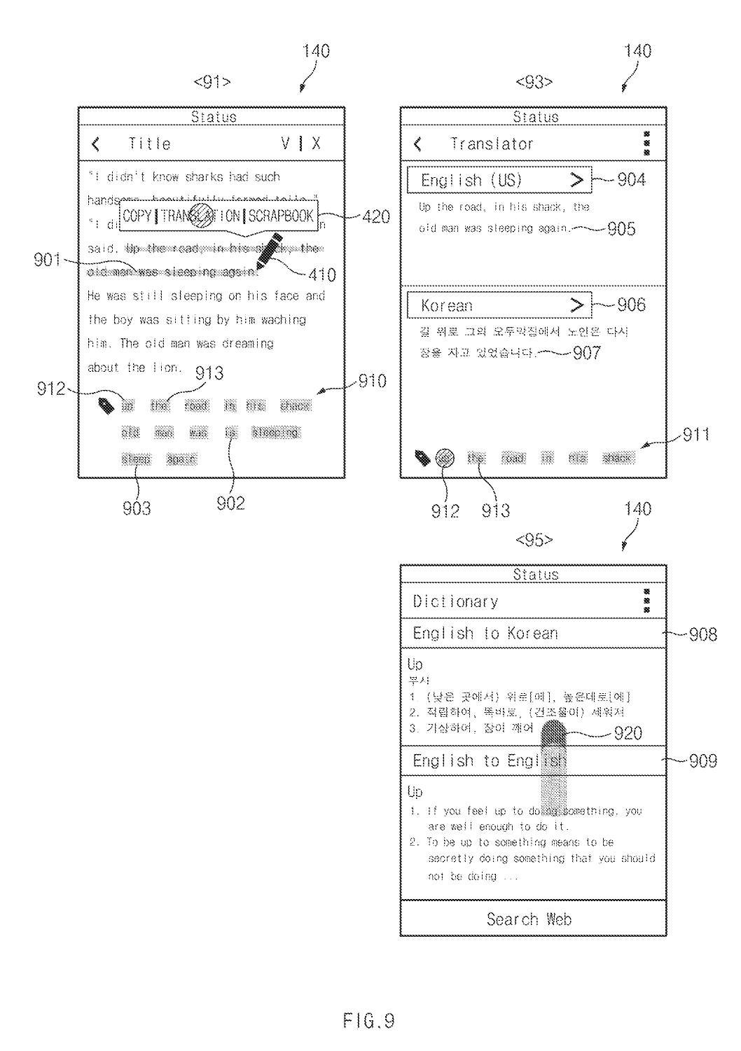

FIG. 9 is a diagram illustrating a screen interface linking a translation function to a dictionary function according to an embodiment of the present disclosure.

Referring to FIG. 9, the display 140 may display screen 91 in response to a specific text display request. The processor 160 may recognize a text block 901 when an event selecting at least some regions of text occurs by using a touch tool (e.g., an electronic pen 410). The processor 160 may display the function classification menu 420 on one side of a screen when text block 901 selection is completed. The processor 160 may perform an error check or an agglutinative language processing and display an analysis result on one side of a screen. In this operation, the display 140 may display “is” 902 or “sleep” 903 that is one of pieces of character information (e.g., the original form of a word) obtained through agglutinative language processing on words included in the text block 901.

The processor 160 may perform a translation function on character information included in the text block 901, when a translation item is selected from the function classification menu 420. The display 140 may display a result obtained by performing a translation function according to the control of the processor 160, as shown on screen 93. On screen 93, the display 140 may display a plurality of translation windows. For example, the display 140 may display at least one of an English translation function item 904, an English translation 905, a Korean translation function item 906, or a Korean translation 907. Also, the display 140 may display, on one side of a screen, some pieces of character information 911 included in pieces of character information 910 obtained through analysis on the text block 901. Also, it is also possible to display words (e.g., similar words or opposite words) associated with the character information 910 on one side of a screen.

When a translation function is selected, the processor 160 may send original character information on a selected text block 901 to a translation engine and display a translated result. For example, it is possible to display the Korean translation 907 for the selected text block 901. Also, the processor 160 may provide character information 910 and 911 (e.g., search word information through the check of the original form of a word) as tag information and link a dictionary function. When character information is selected from character information 910 and 911 by a user input, the processor 160 may perform a dictionary function for selected character information. For example, when “up” 912 is selected from the character information 910 and 911, the processor 160 may display dictionary information on the “up” 912 that is selected character information, as shown on screen 95. In this operation, the processor 160 may display, on the display 140, English-Korean dictionary information 908 or English-English dictionary information 909 on the “up” 912. When a scroll event 920 occurs, the processor 160 may display hidden information on the “up” 912 or display, on the display 140, dictionary information on another piece of character information such as “the” 913.

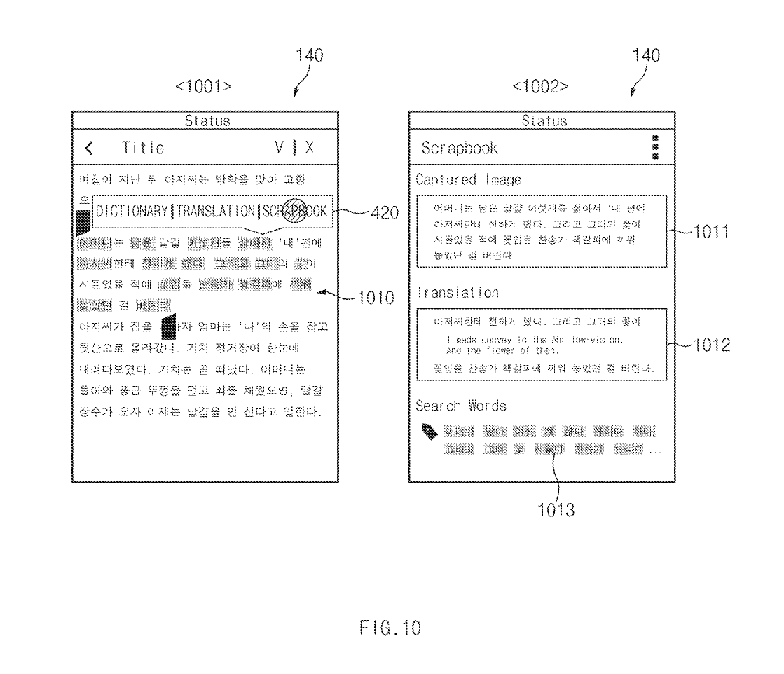

FIG. 10 is a diagram illustrating a screen interface associated with a capture function according to an embodiment of the present disclosure.

Referring to FIG. 10, the display 140 may display a text screen as shown on screen 1001 in response to a text display request. When at least some of text are selected by a touch tool, the processor 160 may recognize selected text as a text block 1010. When the text block 1010 is selected, the processor 160 may identify the characteristics of words included in the text block 1010 selected. When a separated word and connected words are mixed, the processor 160 may propose a capture function (e.g., a scrapbook function), displaying the function classification menu 420 for the text block 1010. When the text block 1010 is selected, the processor 160 may display the function classification menu 420 and also perform the capture function in response to a user touch.

The processor 160 may obtain image data on the text block 1010 when the capture function is performed. In this operation, the processor 160 may perform analysis on character information included in the image data on the text block 1010. The processor 160 may detect translation information corresponding to the text block 1010. For example, the display 140 may display an image 1011 captured by the capture function on a certain region as shown on screen 1002. The display 140 may display a translation result on a certain region when a translation function is applied. For example, the display 104 may display character information on the text block 1010 and a translation result of the character information, on a certain region 1012. According to an embodiment, the processor 160 may display character information obtained by analyzing the text block 1010, as search tag information 1013.

An embodiment of the present disclosure may enable a text block to be selected through a natural pen, finger, voice or eyes input based on the above-described text related function, when foreign-language reading is performed. Also, an embodiment enables convenient learning through a link to a scrapbook app and may provide a dictionary function or translation function for a block selected in response to user selection.

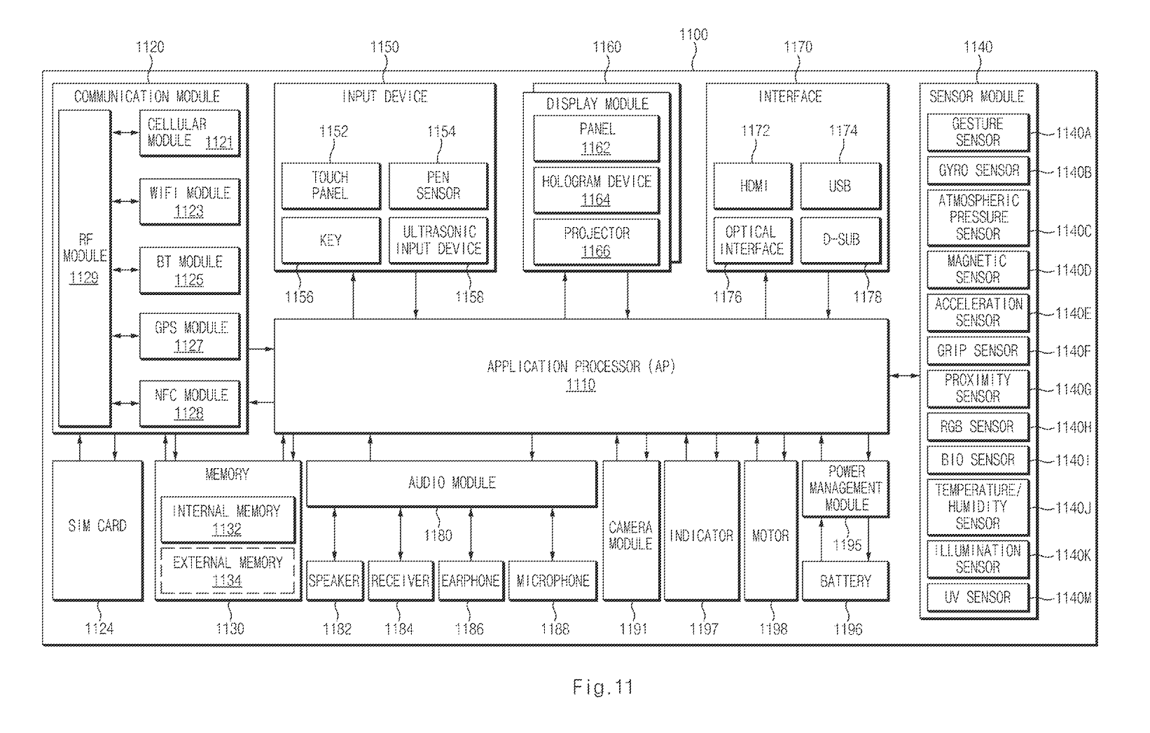

FIG. 11 is a block diagram of an electronic device according to an embodiment of the present disclosure.

Referring to FIG. 11, an electronic device 1100 may include all or some of the electronic device 100 shown in FIG. 1. The electronic device 1100 may include one or more application processors (APs) 1110, a communication module 1120, a subscriber identification module (SIM) card 1124, a memory 1130, a sensor module 1140, an input device 1150, a display 1160, an interface 1170, an audio module 1180, a camera module 1191, a power management module 1195, a battery 1196, an indicator 1197, and a motor 1198.

The AP 1110 may execute an operating system and/or application programs to control a plurality of hardware and software components connected to the AP 1110 and may perform processing and calculation on various pieces of data including multimedia data. The AP 1110 may be implanted in a system on chip (SoC) for example. According to an embodiment, the AP 1110 may further include a graphic processing unit (GPU) (not shown).

The communication module 1120 (e.g., the communication module 110) may perform data transmission and reception when communication is made between the electronic device 1100 (e.g., the electronic device 100) and other electronic devices (e.g., the electronic device 104 or the server device 106) connected through a network. According to an embodiment, the communication module 1120 may include a cellular module 1121, a WiFi module 1123, a BT module 1125, a GPS module 1127, an NFC module 1128, and a radio frequency (RF) module 1129.

The cellular module 1121 may provide a voice call, a video call, a message service, or an internet service through a communication network (such as an LTE, LTE-A, CDMA, WCDMA, UMTS, WiBro or GSM network). Also, the cellular module 1121 may use, for example, a subscriber identity module (such as a SIM card 1124) to perform the identification and authentication of an electronic device in a communication network. The cellular module 1121 may perform at least some functions that the AP 1110 may provide. For example, the cellular module 1121 may perform at least some of multimedia control functions.

The cellular module 1121 may include a communication processor (CP). Also, the cellular module 1121 may be implemented in an SoC, for example. FIG. 11 shows components such as a cellular module 1121 (such as a communication processor), a memory 1130 and a power management module 1195 separately from the AP 1110 but according to an embodiment, the AP 1110 may be implemented to include at least some (such as a cellular module 1121) of the above-described components.

The AP 1110 or the cellular module 1121 (such as a communication processor) may load, on volatile memories, commands or data received from at least one of a non-volatile memory connected to thereto or another component, and may process the commands or data. Also, the AP 1110 or the cellular module 1121 may store, on non-volatile memories, data received from at least one of other components or generated by at least one of other components.

The cellular module 1121 may form a communication channel with the server device 106 that provides at least one of a dictionary information database or a translation information database based on subscriber information included in the SIM card 1124. The cellular module 1121 may receive at least one of a country-based, region-based dictionary information database or translation information database associated with the SIM card 1124 from the server device 106. At least one of a received dictionary information database or a received translation information database may be stored in the memory 1130.

The cellular module 1121 may transmit, to the server device 106, character information on a word's original form or a word associated with the word's original form, such as a word related to tense, a person form or a singular or plural form, a word to which postposition or ending is attached, and a word similar or opposite to a corresponding word. The cellular module 1121 may receive at least one of dictionary information or translation information corresponding to character information transmitted from the server device 106. The dictionary information or the translation information received by the cellular module 1121 may be displayed on the display 1160. According to an embodiment, the dictionary information or translation information received may also be stored in the memory 1130.

The cellular module 1121 may receive text related data from another electronic device or the server device 106. For example, the cellular module 1121 may receive a text message, a multimedia message or an e-mail. The cellular module 1121 may receive a web page including text, E-book content including text or document data including text. Received text related data may be stored in the memory 1130 temporarily or semi-permanently.

Each of the WiFi module 1123, the BT module 1125, the GPS module 1127 and the NFC module 1128 may include a processor for processing data transmitted and received through a corresponding module, for example. FIG. 11 shows each of the cellular module 1121, the WiFi module 1123, the BT module 1125, the GPS module 1127, and the NFC module 1128 as a separate block, but according to an embodiment, at least some (e.g., two or more) of the cellular module 1121, the WiFi module 1123, the BT module 1125, the GPS module 1127, and the NFC module 1128 may be included in one integrated chip (IC) or an IC package. For example, some (such as a communication processor corresponding to the cellular module 1121 and a WiFi processor corresponding to the WiFi module 1123) of the processors corresponding to the cellular module 1125, the WiFi module 1127, the BT module 1128, the GPS module 1121, and the NFC module 1123, respectively may be implemented in one SoC.

The RF module 1129 may perform data transmission and reception, such as transmission and reception of an RF signal. The RF module 1129 may include e.g., a transceiver, a power amp module (PAM), a frequency filter or a low noise amplifier (LNA) though not shown. Also, the RF module 1129 may further include a part such as a conductor or wire for transmitting or receiving electromagnetic waves in a free space when performing wireless communication. Although FIG. 11 shows that the cellular module 1121, the WiFi module 1123, the BT module 1125, the GPS module 1127, and the NFC module 1128 share one RF module 1129, at least one of the cellular module 1121, the WiFi module 1123, the BT module 1125, the GPS module 1127, and the NFC module 1128 may also transmit and receive an RF signal through a separate RF module.

The SIM card 1124 may be a card including a subscriber identification module and may be inserted into a slot that is formed on a specific location on an electronic device. The SIM card 1124 may include unique identification information (such as an integrated circuit card identifier (ICCID)) or subscriber information (such as an international mobile subscriber identity (IMSI)). At least one of country information and region information included in the SIM card 1124 may be detected by the AP 1110. The country information and region information detected may be transferred to the server device 106.

The memory 1130 (such as a memory module 150) may include an internal memory 1132 or an external memory 1134. The internal memory 1132 may include at least one of e.g., a volatile memory (such as a dynamic RAM (DRAM), a static RAM (SRAM), or a synchronous dynamic RAM (SDRAM)) and a non-volatile memory (such as an one time programmable ROM (OTPROM), a programmable ROM (PROM), an erasable and programmable ROM (EPROM), an electrically erasable and programmable ROM (EEPROM), a mask ROM, a flash ROM, a NAND flash memory, or a NOR flash memory).

The internal memory 1132 may be a solid state drive (SSD). The external memory 1134 may further include a flash drive, such as a compact flash (CF) drive, a secure digital (SD) drive, a micro secure digital (micro-SD) drive, a mini secure digital (mini-SD) drive, or an extreme digital (xD) drive, or a memory stick. The external memory 1134 may be functionally connected to the electronic device 1100 through various interfaces. According to an embodiment, the electronic device 1100 may further include a storage device (or storage medium) such as an HDD.

The memory 1130 may store at least one of a dictionary information database or translation information database received from another electronic device or the server device 106 as mentioned previously. Also, the memory 1130 may store text received from another electronic device or the server device 106.

The sensor module 1140 may measure a physical quantity or sense the operation state of the electronic device 1100 to convert measured or sensed information into an electrical signal. The sensor module 1140 may include at least one of a gesture sensor 1140A, a gyro sensor 1140B, an atmospheric pressure sensor 1140C, a magnetic sensor 1140C, an acceleration sensor 1140E, a grip sensor 1140F, a proximity sensor 1140G, a color sensor 1140H (such as a red, green, blue (RGB) sensor), a bio sensor 1140I, a temperature/humidity sensor 1140J, an illumination sensor 1140K or a ultra violet (UV) sensor 1140M, for example. Additionally or alternatively, the sensor module 1140 may include an E-nose sensor (not shown), an electromyography (EMG) sensor (not shown), an electroencephalogram (EEG) sensor (not shown), an electrocardiogram (ECG) sensor (not shown), an infra red (IR) sensor (not shown), an iris sensor (not shown) or a fingerprint sensor (not shown). The sensor module 1140 may further include a control circuit for controlling at least one sensor that is included in the sensor module 1140.

The sensor module 1140 may generate a sensor signal related to text block selection. For example, the sensor module 1140 may generate a sensor signal related to the completion of the text block selection (such as a sensor signal corresponding to a shaking motion, a sensor signal corresponding to a leaning motion, or a sensor signal corresponding to a tapping motion). The sensor module 1140 may also generate a sensor signal related to the negation of the text block selection. For example, when a sensor signal corresponding to a pre-defined gesture motion is generated from the sensor module 1140, the AP 1110 may enable the selection of the text block to be negated.

The sensor module 1140 may generate a sensor signal corresponding to a state of gripping a device based on the grip sensor 1140F. According to a setting, the AP 1110 may activate a text block selection function when a user grips a device and inactivate the text block selection function when the user does not grip the device. According to an embodiment, the sensor module 1140 may include a sensor that senses whether or not the electronic pen 410 is attached. The AP 1110 may activate the text block selection function when the electronic pen 410 is separated from the electronic device while text is displayed on the display(s) 1160, inactivate the text block selection function when the electronic pen 410 is inserted into a creation location on the electronic device.

The input device 1150 may include a touch panel 1152, a (digital) pen sensor 1154, a key 1156 or an ultrasonic input device 1158. The touch panel 1152 may recognize a touch input by using at least one of a capacitive, pressure-sensitive, infrared or ultrasonic techniques, for example. Also, the touch pane 1152 may also further include a control circuit. In the case of the capacitive technique, a physical contact or proximity awareness is possible. The touch panel 1152 may also further include a tactile layer. In this case, the touch panel 1152 may provide a tactile response to a user.

The (digital) pen sensor 1154 (such as an electronic pen 410) may be implemented by using the same or similar method as that of obtaining a user's touch input or by using a separate sheet for recognition, for example. The key 1156 may include a physical button, an optical key or a keypad, for example.

The ultrasonic input device 1158 is a device that may sense sound waves by using a microphone (such as a microphone 1188) from the electronic device 1100 and recognize data, through an input tool generating ultrasonic signals and the ultrasonic input device 1158 may perform wireless recognition. The electronic device 1100 may also use the communication module 1120 to receive a user input from an external device (such as a computer or server device) connected thereto.

The display 1160 (such as a display 140) may include a panel 1162, a hologram device 1164 or a projector 1166. The panel 1162 may be a liquid-crystal display (LCD) or an active-matrix organic light-emitting diode (AM-OLED), for example. The panel 1162 may be implemented flexibly, transparently or embo, for example. The panel 1162 may also be integrated into the touch panel 1152 so that they are implemented in one module. The hologram device 1164 may use the interference of a light to show a stereoscopic image in the air. The projector 1166 may project a light onto a screen to display an image. The screen may be located inside or outside the electronic device 1100, for example. The display 1160 may further include a control circuit for controlling the panel 1162, the hologram device 1164 or the projector 1166.

The interface 1170 may include a high-definition multimedia interface (HDMI) 1172, a universal serial bus (USB) 1174, an optical interface 1176 or a D-subminiature (D-sub) 1178, for example. The interface 1170 may be included in e.g., the communication interface 170 shown in FIG. 1. Additionally or alternatively, the interface 1170 may include a mobile high-definition link (MHL) interface, an SD card/multi-media card (MMC) interface or an infrared data association (IrDA) interface, for example.

The audio module 1180 may convert sound into an electrical signal or vice versa. At least some components of the audio module 1180 may be included in e.g., the input and output interface 140 shown in FIG. 1. The audio module 1180 may process sound information input or output through a speaker 1182, a receiver 1184, an earphone 1186 or the microphone 1188, for example. The audio module 1180 may output audio data related to a text block. For example, the audio module 1180 may output audio data corresponding to words designated by a text block. The audio module 1180 may output audio data corresponding to dictionary information corresponding to words designated by the text block. The audio module 1180 may output audio data corresponding to translation information corresponding to words designated by the text block. The above-described audio data may be stored in the memory 1130 or provided by the server device 106.

The camera module 1191 is a device that may capture still pictures and moving pictures, and it is possible to include one or more image sensors (such as a front sensor or rear sensor), lens (not shown), an image signal processor (ISP, not shown), or a flash (not shown) (e.g., an LED or a xenon lamp).

The power management module 1195 may manage the power of the electronic device 1100. Although not shown, the power management module 1195 may include a power management integrated circuit (PMIC), a charger IC, or a battery or fuel gauge, for example.

The PMIC may be included in an IC or an SoC semiconductor, for example. Charging techniques may be classified into wired and wireless techniques. The charger IC may charge the battery and prevent overvoltage or overcurrent from a charger. According to an embodiment, the charger IC may include a charger IC for at least one of a wired charging technique and a wireless charging technique. The wireless charging technique includes a magnetic resonance type, a magnetic induction type, or an electromagnetic wave type, for example, and an additional circuit for wireless charging may be added such as a coil loop, a resonance circuit, or a rectifier.

The battery gauge may measure the state, current or temperature of the battery 1196, or the voltage of the battery 1196 during charging, for example. The battery 1196 may store or generate electricity and use stored or generated electricity to supply power to the electronic device 1100. The battery 1196 may include a rechargeable battery or a solar battery, for example.

The indicator 1197 may indicate the specific states of the electronic device 1100 or a portion (e.g., the AP 1110) of the electronic device 1100, such as a booting state, a message state or a charged state. According to an embodiment, the indicator 1197 may indicate a state related to the activation of a text block selection function. The indicator 1197 may indicate the states of a text block when a dictionary function, a translation function or a capture function is performed.

The motor 1198 may convert an electrical signal into mechanical vibration. The motor 1198 may output vibration corresponding to a touch event when a text block is designated. Although not shown, the electronic device 1100 may include a processing device (e.g., a GPU) for supporting a mobile TV. The processing device for supporting the mobile TV may process media data according to a standard, for example, such as digital multimedia broadcasting (DMB), digital video broadcasting (DVB) or media flow.

Each of the above-described elements of the electronic device according to the present disclosure may include one or more components and the names of corresponding elements may vary depending on the type of an electronic device. The electronic device according to the present disclosure may include at least one of the above-described elements and some elements may be left out or other elements may be further included. Also, some of the elements of the electronic device according to the present disclosure are combined to form an entity, which may equally perform the functions of corresponding elements before being combined.

The term “module” used in the present disclosure may mean a unit including one of hardware, software and firmware or a combination of two or more thereof, for example. The “module” may be interchangeably used with the term “unit”, “logic”, “logical block”, “component”, or “circuit”, for example. The “module” may be an elementary unit of or a portion of an integral component. The “module” may also be an elementary unit for performing one or more functions or a portion of the elementary unit. The “module” may be implemented mechanically or electronically. For example, the “module” according to the present disclosure may include at least one of an application-specific integrated circuit (ASIC) chip, a field-programmable gate array (FPGA) and a programmable-logic device that perform some operations and have been known or will be developed.

According to an embodiment of the present disclosure, at least some of devices (such as modules or their functions) or methods (such as operations) according to the present disclosure may be implemented as commands stored in a computer-readable storage medium in the form of a programming module, for example. When the command is executed by one or more processors (such as a processor 160), the one or more processors may execute a function corresponding to the command. The computer readable storage medium may be the memory 150, for example. At least a portion of the programming module may be implemented (e.g., performed) by e.g., the processor 160. At least a portion of the programming module may include e.g., a module, a program, a routine, a set of instructions or a process for executing one or more functions.

The computer readable recording medium may include a magnetic medium such as a hard disk, a floppy disk and a magnetic tape, a magneto-optical medium such as a compact disk read only memory (CD-ROM) and a digital versatile disc (DVD), a magneto-optical media such as a floptical disk, and a hardware device that is especially configured to store and execute a program command (such as a programming module), such as a read only memory (ROM), a random access memory (RAM), and a flash memory. Also, the program command may include a machine code made by a compiler as well as a high-level language code that may be executed by a computer by using an interpreter. The above-described hardware device may be configured to operate by one or more software modules to execute the operations of the present disclosure and vice versa.

The module or programming module according to the present disclosure may include at least one of the above-described elements, leave out some elements or further include other elements. Operations executed by a module according to the present disclosure, a programming module or another element may be executed by using a sequential, parallel, repetitive or heuristic method. Also, the execution order of some operations may vary, some operations may be left out or further operations may be added.

An embodiment of the present disclosure relates to a storage medium storing commands, which enable at least one processor to perform at least one operation when being executed by the at least one processor, wherein the at least one operation may include the operation of selecting at least one text region from displayed text, analyzing the connection relationship between at least one piece of character information included in a selected text region to determine at least one classification for the text region or the character information, and the operation of processing a text related function related to at least one piece of character information included in the text region according to determined classification.

The electronic device and method according to an embodiment enables at least one of a dictionary information database or translation database related to a language configuring text to be automatically obtained or selected.

Also, an embodiment of the present disclosure may classify and change content included in text to a form easy to search for dictionary information or translate and may thus provide a more accurate translation.

Also, various embodiments of the present disclosure support a text related function to match the usage form of an actual user so that the user may use the text related function more intuitively and easily.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of operating a text related function, the method comprising:
receiving a selection of at least one text region from displayed text;
determining at least one classification for one of the at least one text region and the character information based on a connection relationship between at least one piece of character information included in the at least one text region selected; and
processing a text related function associated with the at least one piece of character information according to the determined at least one classification.

2. The method according to claim 1, wherein the receiving of the selection comprises determining the at least one text region based on at least one of a closed curve event including some of the text, a line-drawing event, a touch event and a special symbol event.

3. The method according to claim 1, wherein the receiving of the selection comprises determining selected text as the at least one text region when another text is further selected within a designated time period after some of the text is selected.

4. The method according to claim 1, wherein the determining of the at least one classification comprises at least one of:
classifying a word as a separated word when the at least one text region includes a word;
classifying words as connected words when the at least one text region includes a plurality of words; and
classifying words as mixed words when the separated word and the connected words are mixed.

5. The method according to claim 1, wherein the processing of the text related function comprises:
displaying a menu including at least one of a dictionary function, a translation function and a capture function; and
processing a function related to the at least one piece of character information included in the at least one text region, according to a function selected from the menu.

6. The method according to claim 4, wherein the processing of the text related function comprises at least one of:
collecting and displaying dictionary information on a separated word when a text region including the separated word is selected;
collecting and displaying translation information on connected words when a text region including the connected words is selected; and
capturing, displaying and storing a text region as at least one image when the text region including the mixed words is selected.

7. The method according to claim 6, wherein the processing of the text related function further comprises at least one of:
displaying translation information on the separated word;
displaying dictionary information on at least one of the connected words; and
displaying at least one of translation information and dictionary information corresponding to the captured text region.

8. The method according to claim 1, wherein the processing of the text related function comprises at least one of:
performing an error check on the at least one piece of character information included in the at least one text region;
performing agglutinative language processing on the at least one piece of character information included in the at least one text region and extracting a word's original form; and
performing inflectional language processing on the at least one piece of character information included in the at least one text region and extracting a word's original form.

9. The method according to claim 8, wherein the processing of the text related function further comprises at least one of:
displaying dictionary information on the word's original form;
displaying, at least one of the at least one piece of character information included in the at least one text region and the word's original form according to one of the agglutinative language processing and the inflectional language processing, as tag information;
displaying, at least one of words similar and opposite to the at least one of the character information and the word's original form, as tag information.

10. The method according to claim 1, further comprising:
checking one of subscriber identity module (SIM) information on an electronic device and information on a carrier currently providing a service;
checking one of country-based information, region-based information on the SIM information and the information on the carrier currently providing the service; and
receiving at least one of a dictionary information database and a translation information database supporting the text related function from a server device according to one of a country and a region.

11. An electronic device comprising:
an input and output interface configured:
to sense at least one of a closed curve event including some of displayed text, a line-drawing event, a touch event, and a special symbol event, and
to select at least one text region based on the at least one event; and
a processor configured:
to determine the at least one text region based on selection,
to analyze the connection relationship between the at least one piece of character information included in the at least one text region to determine at least one classification for the text region, and
to process a text related function related to the at least one piece of character information included in the at least one text region according to the determined at least one classification.

12. The electronic device according to claim 11, wherein the processor is further configured to determine the at least one text region based on at least one of a closed curve event including some of the text, a line-drawing event, a touch event and a special symbol event.

13. The electronic device according to claim 11, wherein the processor is further configured to determine the selected text as the at least one text region when another text is further selected within a designated time period after some of text are selected.

14. The electronic device according to claim 11, wherein the processor is further configured:
to classify a word as a separated word when the at least one text region includes a word,
to classify words as connected words when the at least one text region includes a plurality of words, and
to classify words as mixed words when the separated word and the connected words are mixed.

15. The electronic device according to claim 14, wherein the processor is further configured:
to display dictionary information on a separated word when a text region including the separated word is selected;
to display translation information on connected words when a text region including the connected words is selected; and
to capture, display and store a text region as at least one image when the text region including the mixed words is selected.

16. The electronic device according to claim 15, wherein the processor is further configured to display of at least one of dictionary information and translation information corresponding to the captured text region, dictionary information on at least one of the connected words and translation information on the separated word.

17. The electronic device according to claim 11, wherein the processor is further configured to perform at least one of an error check on the at least one piece of character information included in the at least one text region, and agglutinative language processing and inflectional language processing for extracting a word's original form on the at least one piece of character information included in the at least one text region.

18. The electronic device according to claim 17, wherein the processor is further configured to display at least one of the at least one piece of character information included in the at least one text region, the word's original form according to one of the agglutinative language processing and inflectional language processing, dictionary information on the word's original form, and words similar and opposite to the at least one of the character information and the word's original form.

19. The electronic device according to claim 11, wherein the processor is further configured to receive at least one of a dictionary information database and a translation information database supporting the text related function from a server device, according to one of SIM information on an electronic device and one of country-based and region-based information on information on a carrier currently providing a service.

20. A storage medium storing commands enabling at least one processor to perform at least one operation when being executed by the at least one processor, wherein the at least one operation comprises:
selecting at least one text region from displayed text, analyzing the connection relationship between the at least one piece of character information included in the selected text region to determine at least one classification for one of the at least one text region and the at least one piece of character information, and processing a text related function related to the at least one piece of character information included in the at least one text region according to the determined at least one classification

21. The storage medium according to claim 20, wherein, when the processing of the text related function determines that the selected at least one text region is grammatically incorrect, modify the selected at least one text region to a grammatically correct form.
